(19) United States
(12) Patent Application Publication
(10) Pub. No.: US 2019/0071101 A1
(43) Pub. Date: Mar. 7, 2019

(54) DRIVING ASSISTANCE METHOD, DRIVING ASSISTANCE DEVICE WHICH UTILIZES SAME, AUTONOMOUS DRIVING CONTROL DEVICE, VEHICLE, DRIVING ASSISTANCE SYSTEM, AND PROGRAM

(71) Applicant: Panasonic Intellectual Property Management Co., Ltd., Osaka (JP)

(72) Inventors: KOICHI EMURA, Kanagawa (JP); HIDETO MOTOMURA, Kyoto (JP); SAHIM KOURKOUSS, Osaka (JP); YOSHIHIDE SAWADA, Tokyo (JP); MASANAGA TSUJI, Osaka (JP); TOSHIYA MORI, Osaka (JP)

(21) Appl. No.: 16/084,585

(22) PCT Filed: Feb. 14, 2017
(86) PCT No.: PCT/JP2017/005216

§ 371 Date: Sep. 13, 2018

(30) Foreign Application Priority Data
Mar. 25, 2016 (JP) 2016-062683

(51) Int. Cl. B60W 50/14; G05D 1/00

(52) U.S. Cl. CPC B60W 50/14; G05D 1/0088

(57) ABSTRACT

An automation level determination section selects one of automation levels defined at a plurality of stages based on a deviation degree of reliability, the deviation degree corresponding to each of a plurality of kinds of driving behaviors that are estimation results obtained using a driving behavior model. A generator generates presentation information by applying the plurality of kinds of driving behaviors to an output template corresponding to one selected automation level in output templates corresponding to the automation levels defined at the plurality of stages respectively. An output unit outputs the presentation information that is generated.

### TECHNICAL FIELD

The present invention relates to a vehicle, a driving assistance method applied to the vehicle and a driving assistance device which utilizes the driving assistance method, an automatic driving control device, a driving assistance system, and a program.

### BACKGROUND ART

An automatic driving vehicle detects a situation around the vehicle to automatically execute a driving behavior, thereby traveling. A vehicle operating device is mounted on the automatic driving vehicle in order that an occupant instantaneously changes a behavior of the automatic driving vehicle. The vehicle operating device presents the executable driving behavior to cause the occupant to select the driving behavior (For example, see PTL 1).

### CITATION LIST

### Patent Literature

PTL 1: WO 15/141308

### Non-Patent Literature

NPL 1: “Design of Symbiosis between Human and Machine “Inquiry into Human-centered Automation””, pp. 111 to 118, Morikita Publishing Co., Ltd, T. B. Sheridan, Telerobotics, “Automation and Human Supervisory Control”, MIT Press, 1992., T. Inagaki, et al, “Trust, self-confidence and authority in human-machine systems”, Proc. IFAC HMS, 1998.

### SUMMARY OF THE INVENTION

An object of the present invention is to provide a technique of adequately notifying the occupant of the executable driving behavior according to reliability of presented information.

A driving assistance device according to an aspect of the present invention includes an automation level determination section, a generator, and an output unit. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

Another aspect of the present invention provides an automatic driving control device. The automatic driving control device includes an automation level determination section, a generator, an output unit, and an automatic driving controller. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator. The automatic driving controller controls automatic driving of a vehicle based on one of the plurality of kinds of driving behaviors.

Still another aspect of the present invention provides a vehicle. The vehicle includes a driving assistance device. The driving assistance device includes an automation level determination section, a generator, and an output unit. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

Still another aspect of the present invention provides a driving assistance system. The driving assistance system includes a server that generates a driving behavior model and a driving assistance device that receives the driving behavior model generated by the server. The driving assistance device includes an automation level determination section, a generator, and an output unit. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

Still another aspect of the present invention provides a driving assistance method. The driving assistance method includes the steps of selecting an automation level, generating presentation information, and outputting the presentation information that is generated. In the step of selecting the automation level, one of automation levels defined at a plurality of stages is selected based on a deviation degree of reliability, the deviation degree corresponding to each of a plurality of kinds of driving behaviors that are estimation results obtained using a driving behavior model. In the step of generating the presentation information, the presentation information is generated by applying the plurality of kinds of driving behaviors to an output template corresponding to one selected automation level in output templates corresponding to the automation levels defined at the plurality of stages respectively.

Any desired combinations of the above described components and the features in which the representation of the present invention is converted between the devices, systems, methods, programs, non-transitory recording media having the programs recorded on the non-transitory recording media, vehicles having the present device mounted on the vehicles, or other entities are still effective as other aspects of the present invention.

According to the present invention, the occupant can adequately be notified of the driving behavior according to the reliability of the presented information.

### BRIEF DESCRIPTION OF DRAWINGS

FIG. 1 is a view illustrating a configuration of a vehicle according to an exemplary embodiment.

FIG. 2 is a view schematically illustrating an interior of the vehicle in FIG. 1.

FIG. 3 is a view illustrating a configuration of a controller in FIG. 1.

FIG. 4 is a view illustrating an outline of action of an automation level determination section in FIG. 3.

FIG. 5 is a view illustrating a configuration of an output template stored in an output template storage of FIG. 3.

FIG. 6 is a view illustrating a configuration of another output template stored in the output template storage of FIG. 3.

FIG. 7 is a view illustrating a configuration of still another output template stored in the output template storage of FIG. 3.

FIG. 8A is a view illustrating a configuration of presentation information generated by a generator in FIG. 3.

FIG. 8B is a view illustrating the configuration of the presentation information generated by the generator in FIG. 3.

FIG. 9 is a flowchart illustrating an output procedure of a display controller in FIG. 3.

### DESCRIPTION OF EMBODIMENT

Before some exemplary embodiments of the present invention are described, a problem associated with conventional systems will be described briefly. In the automation system of the automatic driving vehicle, the reliability of the presented executable driving behavior fluctuates due to a situation around the vehicle that changes moment by moment or a performance limit of a sensor that detects the situation around the vehicle. In the case that the occupant selects the presented executable driving behavior while not comprehending the fluctuation of the reliability, there is a risk of generating distrust of the automation system. When notification of a determination result of the automation system is made by an interface in which a presentation method is hardly changed, the driver has the distrust of the system from the low-reliability determination result or overconfidence of the system from the high-reliability determination result. Inquiring the driver of a measure of the high-reliability determination result every time may cause the driver to feel bothersome, or cause the driver who feels bothersome to overlook the important determination result in which the measure should be taken.

Prior to specific description of the exemplary embodiment, an outline of the present invention will be described. The exemplary embodiment relates to automatic driving of the vehicle. In particular, the exemplary embodiment relates to a device (hereinafter, also referred to as a “driving assistance device”) that controls a Human Machine Interface (HMI) for exchanging information about a driving behavior of the vehicle with an occupant (for example, a driver) of the vehicle. Various terms in the exemplary embodiment are defined as follows. The “driving behavior” includes an operating state such as steering and braking during traveling and stopping of the vehicle, or a control content relating to the automatic driving control. For example, the driving behavior is constant speed traveling, acceleration, deceleration, temporary stop, stop, lane change, course change, right or left turn, parking, and the like. The driving behavior may be cruising (running while keeping a lane and maintaining a vehicle speed), lane keeping, following a preceding vehicle, stop and go during following, lane change, passing, a response to a merging vehicle, crossover (interchange) including entry and exit to and from an expressway, merging, response to a construction zone, response to an emergency vehicle, response to an interrupting vehicle, response to lanes exclusive to right and left turns, interaction with a pedestrian and a bicycle, avoidance of an obstacle other than a vehicle, response to a sign, response to restrictions of right and left turns and a U turn, response to lane restriction, response to one-way traffic, response to a traffic sign, response to an intersection and a roundabout, and the like.

Deep Learning (DL), Machine Learning (ML), filtering, or a combination of these schemes is used as a “driving behavior estimating engine”. For example, the Deep Learning is a Convolutional Neural Network (CNN) or an Recurrent Neural Network (RNN). For example, the Machine Learning is a Support Vector Machine (SVM). For example, the filter is collaborative filtering.

A “driving behavior model” is uniquely decided according to the driving behavior estimating engine. The driving behavior model is the learned neural network for the DL, the driving behavior model is the learned prediction model for the SVM, and the driving behavior model is data in which traveling environment data and driving behavior data are linked together for the collaborative filtering. A rule base is held as a previously decided criterion, and the driving behavior model is data in which input and output are linked together in the case that each of a plurality of kinds of behaviors is indicated to be dangerous or not dangerous in the rule base.

Under the above definitions, in this case, the driving behavior is derived using the driving behavior model generated by the machine learning or the like. The reliability of the driving behavior changes according to the situation around the vehicle, the performance limit of a sensor, and a previous learning content. In the case that the predicted driving behavior has the high reliability, a driver may follow the predicted driving behavior. However, in the case that the predicted driving behavior has the low reliability, sometimes the driver may not follow the predicted driving behavior. For this reason, in the case that the driving behavior is presented, desirably the driver comprehends the reliability of the driving behavior. In the exemplary embodiment, an output method is changed according to the reliability of each of the driving behavior models. As used herein, the reliability indicates a probability of the derived driving behavior. The reliability corresponds to an accumulated value of estimation result for the DL, corresponds to a confidence value for the SVM, and corresponds to a correlation degree for the collaborative filtering. The reliability corresponds to reliability of a rule for the rule base.

Hereinafter, the exemplary embodiment of the present invention will be described in detail with reference to the drawings. The exemplary embodiment described below is only illustrative, and the present invention is not limited to the exemplary embodiment.

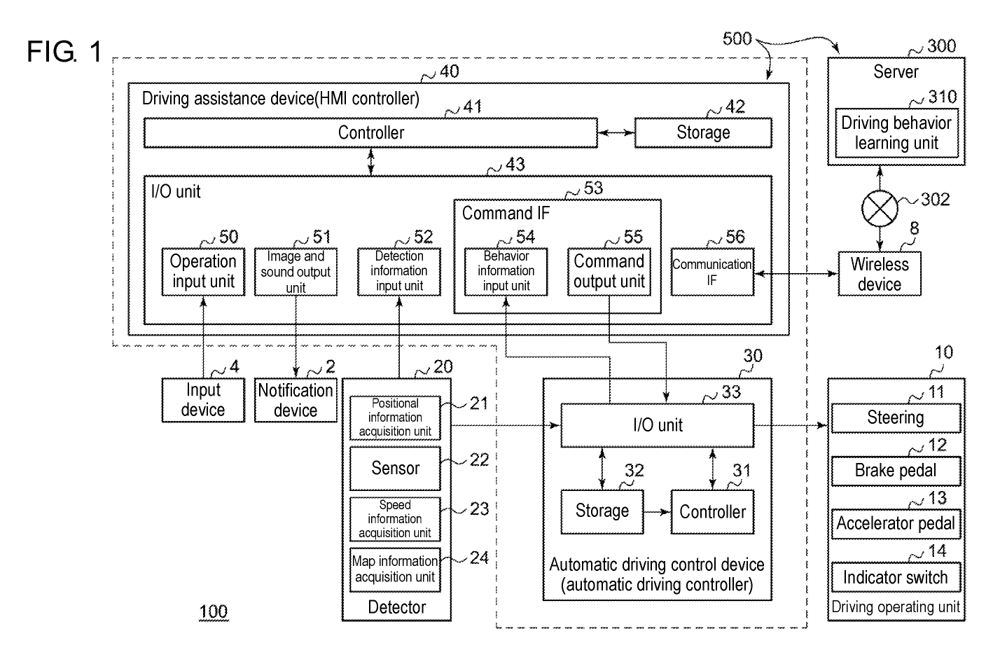

FIG. 1 illustrates a configuration of vehicle 100 of the exemplary embodiment, and particularly illustrates a configuration relating to automatic driving. Vehicle 100 can travel in an automatic driving mode, and includes notification device 2, input device 4, wireless device 8, driving operating unit 10, detector 20, automatic driving control device 30, and driving assistance device (MHI controller) 40. The devices in FIG. 1 may be connected by a dedicated line or wired communication such as a Controller Area Network (CAN). The devices may be connected by wired communication or wireless communication such as a Universal Serial Bus (USB), Ethernet (registered trademark), Wi-Fi (registered trademark), and Bluetooth (registered trademark).

Notification device 2 notifies the driver of information about traveling of vehicle 100. Notification device 2 is a display for displaying information, such as a light emitter, for example, an Light Emitting Diode (LED) provided on a car navigation system, a head-up display, a center display, a steering wheel, a pillar, a dashboard, and a vicinity of an instrument panel, all of these elements are installed in a vehicle interior. Notification device 2 may be a speaker that converts information into sound to notify the driver, or a vibrator provided at a position (for example, a seat of the driver and a steering wheel) where the driver can sense a vibration. Notification device 2 may be a combination of these elements. Input device 4 is a user interface device that receives an operation input performed by an occupant. For example, input device 4 receives information about the automatic driving of the own vehicle, the information being input by the driver. Input device 4 outputs the received information as an operation signal to driving assistance device 40.

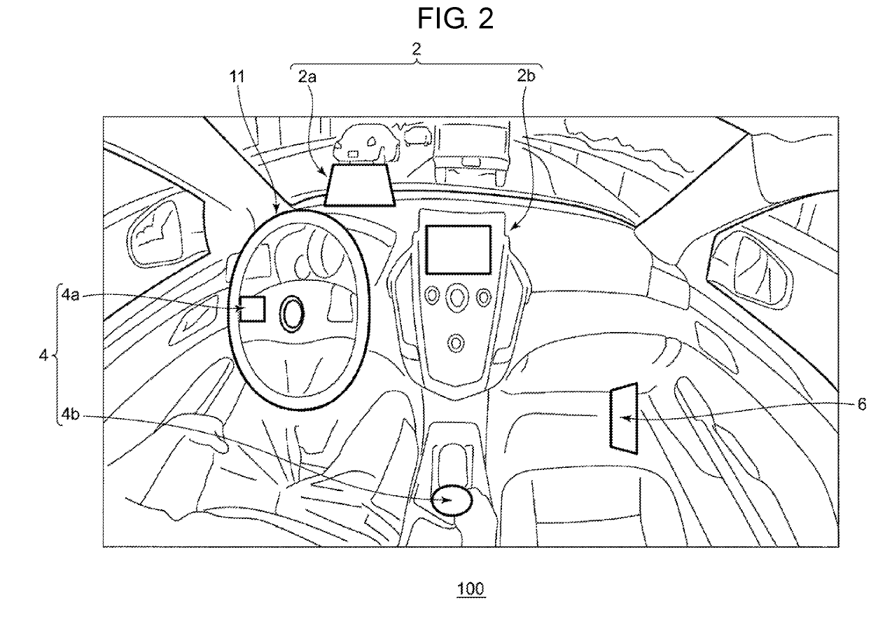

FIG. 2 schematically illustrates an interior of vehicle 100. Notification device 2 may be head-up display (HUD) 2a or center display 2b. Input device 4 may be first operating unit 4a provided in steering 11 or second operating unit 4b provided between a driver seat and a passenger seat. Notification device 2 and input device 4 may be integrated with each other. For example, notification device 2 and input device 4 may be mounted as a touch panel display. Speaker 6 that presents sound information about the automatic driving to the occupant may be provided in vehicle 100. In this case, driving assistance device 40 may cause notification device 2 to display an image indicating the information about the automatic driving, and in addition to or in place of this configuration, may output sound indicating the information about the automatic driving from speaker 6. The description returns to FIG. 1.

Wireless device 8 is adapted to a mobile phone communication system, a Wireless Metropolitan Area Network (WMAN), or the like, and conducts wireless communication. Specifically, wireless device 8 communicates with server 300 through network 302. Server 300 is a device outside vehicle 100, and includes driving behavior learning unit 310. Driving behavior learning unit 310 will be described later. Server 300 and driving assistance device 40 are included in driving assistance system 500.

Driving operating unit 10 includes steering 11, brake pedal 12, accelerator pedal 13, and indicator switch 14. Steering 11, brake pedal 12, accelerator pedal 13, and indicator switch 14 can be electronically controlled by a steering Electronic Control Unit (ECU), a brake ECU, at least one of an engine ECU and a motor ECU, and an indicator controller. In the automatic driving mode, the steering ECU, the brake ECU, the engine ECU, and the motor ECU drive actuators according to control signals supplied from automatic driving control device 30. The indicator controller turns on or off an indicator lamp according to the control signal supplied from automatic driving control device 30.

Detector 20 detects a surrounding situation and a traveling state of vehicle 100. For example, detector 20 detects a speed of vehicle 100, a relative speed of a preceding vehicle with respect to vehicle 100, a distance between vehicle 100 and the preceding vehicle, a relative speed of a vehicle traveling in an adjacent lane with respect to vehicle 100, a distance between vehicle 100 and the vehicle traveling in the adjacent lane, and positional information about vehicle 100. Detector 20 outputs detected various pieces of information (hereinafter, referred to as “detection information”) to automatic driving control device 30 and driving assistance device 40. Detector 20 includes positional information acquisition unit 21, sensor 22, speed information acquisition unit 23, and map information acquisition unit 24.

Positional information acquisition unit 21 acquires a current position of vehicle 100 from a Global Positioning System (GPS) receiver. Sensor 22 is a general term for various sensors that detect an outside situation of the vehicle and the state of vehicle 100. For example, a camera, a millimeter-wave radar, a Light Detection and Ranging Laser Imaging Detection and Ranging (LIDAR), a temperature sensor, an atmospheric pressure sensor, a humidity sensor, and an illuminance sensor are mounted as the sensor that detects the outside situation of the vehicle. The outside situation of the vehicle includes a situation of a road where the own vehicle travels, which includes lane information, an environment including weather, a surrounding situation of the own vehicle, and other vehicles (such as other vehicles traveling in the adjacent lane) present nearby. Any information about the outside of the vehicle that can be detected by sensor 22 may be used. For example, an acceleration sensor, a gyroscope sensor, a geomagnetism sensor, and an inclination sensor are mounted as the sensor 22 that detects the state of vehicle 100.

Speed information acquisition unit 23 acquires a current speed of vehicle 100 from a vehicle speed sensor. Map information acquisition unit 24 acquires map information about a region around the current position of vehicle 100 from a map database. The map database may be recorded in a recording medium in vehicle 100, or downloaded from a map server through a network at a time of use.

Automatic driving control device 30 is an automatic driving controller having an automatic driving control function, and decides a behavior of vehicle 100 in automatic driving. Automatic driving control device 30 includes controller 31, storage unit 32, and I/O unit (input and output unit) 33. A configuration of controller 31 can be implemented by cooperation between a hardware resource and a software resources or only the hardware resource. A processor, a Read Only Memory (ROM), a Random Access Memory (RAM), and other LSIs (Large Scale Integrated Circuits) can be used as the hardware resource, and programs such as an operating system, an application, and firmware can be used as the software resource. Storage unit 32 includes a non-volatile recording medium such as a flash memory. I/O unit 33 executes communication control according to various communication formats. For example, I/O unit 33 outputs information about the automatic driving to driving assistance device 40, and receives a control command from driving assistance device 40. I/O unit 33 receives the detection information from detector 20.

Controller 31 applies a control command input from driving assistance device 40 and various pieces of information collected from detector 20 or various ECUs to an automatic driving algorithm, and calculates a control value in order to control an automatic control target such as a travel direction of vehicle 100. Controller 31 transmits the calculated control value to the ECU or the controller for each control target. In the exemplary embodiment, controller 31 transmits the calculated control value to the steering ECU, the brake ECU, the engine ECU, and the indicator controller. For an electrically driven vehicle or a hybrid car, controller 31 transmits the control value to the motor ECU instead of or in addition to the engine ECU.

Driving assistance device 40 is an HMI controller that executes an interface function between vehicle 100 and the driver, and includes controller 41, storage unit 42, and I/O unit 43. Controller 41 executes various pieces of data processing such as HMI control. Controller 41 can be implemented by the cooperation between the hardware resource and the software resource or only the hardware resource. A processor, a ROM, a RAM, and other LSIs can be used as the hardware resource, and programs such as an operating system, applications, and firmware can be used as the software resource.

Storage unit 42 is a storage area that stores data that is looked up or updated by controller 41. For example, storage unit 42 is implemented by a non-volatile recording medium such as a flash memory. I/O unit 43 executes various kinds of communication control according to various kinds of communication formats. I/O unit 43 includes operation input unit 50, image and sound output unit 51, detection information input unit 52, command interface (IF) 53, and communication IF 56.

Operation input unit 50 receives an operation signal generated by operation performed on input device 4 by the driver, the occupant, or a user outside vehicle from input device 4, and outputs the operation signal to controller 41. Image and sound output unit 51 outputs image data or a sound message, which is generated by controller 41, to notification device 2, and causes notification device 2 to display the image data or sound message. Detection information input unit 52 receives information (hereinafter referred to as “detection information”), which is a result of detection processing of detector 20 and indicates a current surrounding situation and a traveling state of vehicle 100, from detector 20, and outputs the received information to controller 41.

Command IF 53 executes interface processing with automatic driving control device 30, and includes behavior information input unit 54 and command output unit 55. Behavior information input unit 54 receives information about the automatic driving of vehicle 100, the information being transmitted from automatic driving control device 30, and outputs the received information to controller 41. Command output unit 55 receives a control command instructing automatic driving control device 30 on a mode of the automatic driving from controller 41, and transmits the command to automatic driving control device 30.

Communication IF 56 executes interface processing with wireless device 8. Communication IF 56 transmits the data, which is output from controller 41, to wireless device 8, and wireless device 8 transmits the data to an external device. Communication IF 56 receives data transmitted from the external device, the data being transferred by wireless device 8, and outputs the data to controller 41.

At this point, automatic driving control device 30 and driving assistance device 40 are individually formed. As a modification, automatic driving control device 30 and driving assistance device 40 may be integrated into one controller as indicated by a broken line in FIG. 1. In other words, one automatic driving control device may have both the functions of automatic driving control device 30 and driving assistance device 40 in FIG. 1.

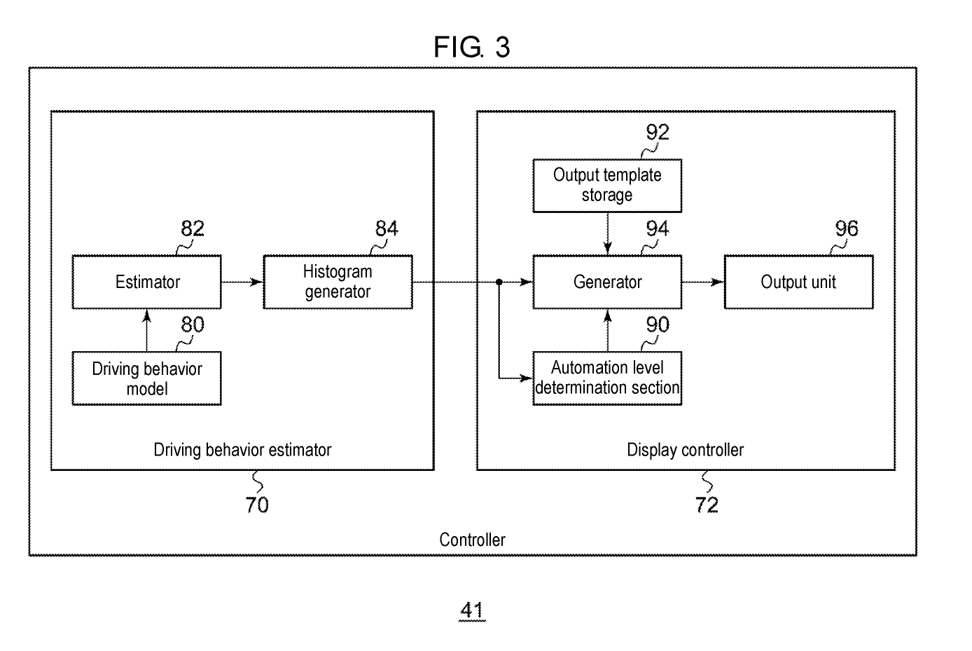

FIG. 3 illustrates a configuration of controller 41. Controller 41 includes driving behavior estimator 70 and display controller 72. Driving behavior estimator 70 includes driving behavior model 80, estimator 82, and histogram generator 84. Display controller 72 includes automation level determination section 90, output template storage 92, generator 94, and output unit 96.

Driving behavior estimator 70 uses the neural network (NN) previously constructed by learning in order to determine the executable driving behavior in the current situation in the plurality of driving behaviors that may be executed by vehicle 100. At this point, the plurality of executable driving behaviors may be provided, and it is said that the determination of the driving behavior is to estimate the driving behavior.

The processing of driving behavior estimator 70 is also associated with driving behavior learning unit 310 of server 300 in FIG. 1, therefore the processing of driving behavior learning unit 310 will be described first. Driving behavior learning unit 310 inputs at least one of the driving histories and traveling histories of the plurality of drivers to the neural network as a parameter. Driving behavior learning unit 310 optimizes a weight of the neural network such that the output from the neural network is matched with taught data corresponding to the input parameter. Driving behavior learning unit 310 generates driving behavior model 80 by repeatedly performing such the processing. That is, driving behavior model 80 is the neural network in which the weight is optimized. Server 300 outputs driving behavior model 80 generated by driving behavior learning unit 310 to driving assistance device 40 through network 302 and wireless device 8. Driving behavior learning unit 310 updates driving behavior model 80 based on a new parameter, and updated driving behavior model 80 may be output to driving assistance device 40 in real time or with a delay.

Driving behavior model 80, which is generated by driving behavior learning unit 310 and input to driving behavior estimator 70, is the neural network constructed using at least one of driving histories and traveling histories of a plurality of drivers. Driving behavior model 80 may be the neural network in which the traveling histories and the neural network constructed using traveling histories of the plurality of drivers are reconstructed by the traveling history and transfer learning using the traveling history of the specific driver. A known technique only has to be used in the construction of the neural network, therefore the description will be omitted. Driving behavior estimator 70 in FIG. 3 includes one driving behavior model 80. Alternatively, a plurality of driving behavior models 80 may be included in driving behavior estimator 70 in each of the drivers, the occupants, the traveling scenes, the weather conditions, and the countries.

Estimator 82 estimates the driving behavior using driving behavior model 80. At this point, the driving history indicates a plurality of feature quantities (hereinafter, referred to as a “feature quantity set”), each of which corresponds to each of the plurality of driving behaviors performed by vehicle 100 in the past. For example, the plurality of feature quantities corresponding to the driving behaviors are an amount indicating the traveling state of vehicle 100 at a predetermined time before the driving behavior is performed by vehicle 100. Examples of the feature quantity include the number of fellow passengers, speed of vehicle 100, motion of a steering handle, a degree of braking, and a degree of acceleration. The driving history may be referred to as a driving characteristic model. Examples of the feature quantity include a feature quantity relating to speed, a feature quantity relating to steering, a feature quantity relating to operation timing, a feature quantity relating to vehicle exterior sensing, and a feature quantity relating to vehicle interior sensing. These feature amounts are detected by detector 20 in FIG. 1, and input to estimator 82 through I/O unit 43. These feature quantities may be added to the traveling histories of the plurality of drivers, and newly used in reconstruction of the neural network. These feature quantities may be added to the traveling history of the specific driver, and newly used in reconstruction of the neural network.

The driving history indicates a plurality of environmental parameters (hereinafter, referred to as an “environmental parameter set”), each of which corresponds to each of the plurality of driving behaviors performed by vehicle 100 in the past. For example, the plurality of environmental parameters corresponding to the driving behaviors are a parameter indicating an environment (surrounding state) of vehicle 100 at a predetermined time before the driving behavior is performed by vehicle 100. Examples of the environmental parameter include a speed of the own vehicle, a relative speed of a preceding vehicle relative to the own vehicle, and a distance between the preceding vehicle and the own vehicle. These environmental parameters are detected by detector 20 in FIG. 1, and input to estimator 82 through I/O unit 43. These environmental parameters may be added to the traveling histories of the plurality of drivers, and newly used in reconstruction of the neural network. These environmental parameters may be added to the traveling history of the specific drivers, and newly used in reconstruction of the neural network.

Estimator 82 acquires the feature quantity set or environmental parameter, which is included in the driving history or the traveling history, as an input parameter. Estimator 82 inputs the input parameter to the neural network of driving behavior model 80, and outputs the output from the neural network to histogram generator 84 as an estimation result.

Histogram generator 84 acquires the driving behavior and the estimation result corresponding to each driving behavior from estimator 82, and generates a histogram indicating the accumulated value of the estimation result corresponding to the driving behavior. Consequently, the histogram includes a plurality of kinds of driving behaviors and the accumulated value corresponding to each driving behavior. As used herein, the accumulated value means a value obtained by accumulating the number of times the estimation result corresponding to the driving behavior is derived. Histogram generator 84 outputs the generated histogram to automation level determination section 90.

Automation level determination section 90 receives the histogram, namely, the plurality of kinds of driving behaviors and the accumulated value corresponding to each driving behavior from histogram generator 84, and specifies the automation level based on the plurality of kinds of driving behaviors and the accumulated value corresponding to each driving behavior. At this point, the automation level is defined at a plurality of stages according to a degree at which the driver needs to monitor a traffic condition or a range in which the driver is responsible for the operation of the vehicle. That is, the automation level is a concept about decision of what to do and how the human and the automation system cooperate with each other in doing it. For example, the automation level is disclosed in Inagaki, “Design of Symbiosis between Human and Machine “Inquiry into Human-centered Automation””, pp. 111 to 118, Morikita Publishing Co., Ltd, T. B. Sheridan, Telerobotics, “Automation and Human Supervisory Control”, MIT Press, 1992., and T. Inagaki, et al, “Trust, self-confidence and authority in human-machine systems”, Proc. IFAC HMS, 1998.

In this case, for example, the automation level is defined at 11 stages. In an automation level “1”, a human decides and executes all without assistance of a computer. In an automation level “2”, the computer presents all options, and the human selects and executes one of the options. In an automation level “3”, the computer presents all executable options to the human, and selects and presents one of the executable options, and the human decides whether the selected executable option is executed. In an automation level “4”, the computer selects one of the executable options, and presents the selected executable option to the human, and the human decides whether the selected executable option is executed. In an automation level “5”, the computer presents one plan to the human, and executes the plan when the human accepts the plan.

In an automation level “6”, the computer presents one plan to the human, and executes the plan unless the human commands the computer to stop the execution within a fixed time. In an automation level “6.5”, the computer presents one plan to the human, and at the same time, executes the plan. In an automation level “7”, the computer does everything, and notifies the human of what the computer did. In an automation level “8”, the computer decides and does everything, and notifies the human of what the computer did when the human asks the computer what the computer did. In an automation level “9”, the computer decides and does everything, and notifies the human of what the computer did when the computer recognizes necessity. In an automation level “10”, the computer decides and does everything. In this way, the automation is not achieved and everything is fully manually operated at the lowest automation level “1”, and the automation is completely achieved at the highest automation level “10”. That is, with increasing automation level, the processing performed by the computer becomes dominant.

The processing of automation level determination section 90 will sequentially be described below. First, automation level determination section 90 squares a difference value between a median of a sum of the accumulated values of the histogram and the accumulated value of each driving behavior. This is because a distance from the median is required to be derived in view of the point that the difference becomes both positive and negative values. Then, automation level determination section 90 derives the deviation degree of a shape of the histogram, namely, the deviation degree indicating how narrow a range the accumulated value of each driving behavior concentrates from difference of a square value of each driving behavior. For example, when the square value of each driving behavior falls within a predetermined range, the shape of the histogram has the small deviation degree. On the other hand, when the square value of at least one driving behavior is larger than other square values by a predetermined value or more, the shape of the histogram has the large deviation degree. When the shape of the histogram has the large deviation degree, automation level determination section 90 calculates a value as a peak degree by subtracting the median of the accumulated values of remaining driving behaviors from the accumulated value in descending order of the accumulated value of the driving behavior of the histogram. Automation level determination section 90 counts the peak degree larger than a predetermined value as a peak to calculate the number of peaks.

Automation level determination section 90 derives the deviation degree and the number of peaks based on the accumulated value that is the reliability corresponding to each of the plurality of kinds of driving behaviors that are the estimation results obtained using the driving behavior model generated by the machine learning or the like. Automation level determination section 90 selects one of the automation levels defined at the plurality of stages based on the deviation degree and the number of peaks. For example, automation level determination section 90 selects the automation level “1” when the number of driving behaviors is 0. Automation level determination section 90 selects the automation level “2” for the small deviation degree. Automation level determination section 90 selects the automation level “3” in the case that the number of peaks is greater than or equal to 2, and selects one of the automation levels 3 to 10 in the case that the number of peaks is 1. At this point, automation level determination section 90 selects one of the automation levels 3 to 10 according to a predetermined value of the deviation degree or the peak degree. Automation level determination section 90 notifies generator 94 of the selected automation level and the plurality of kinds of driving behaviors included in the histogram.

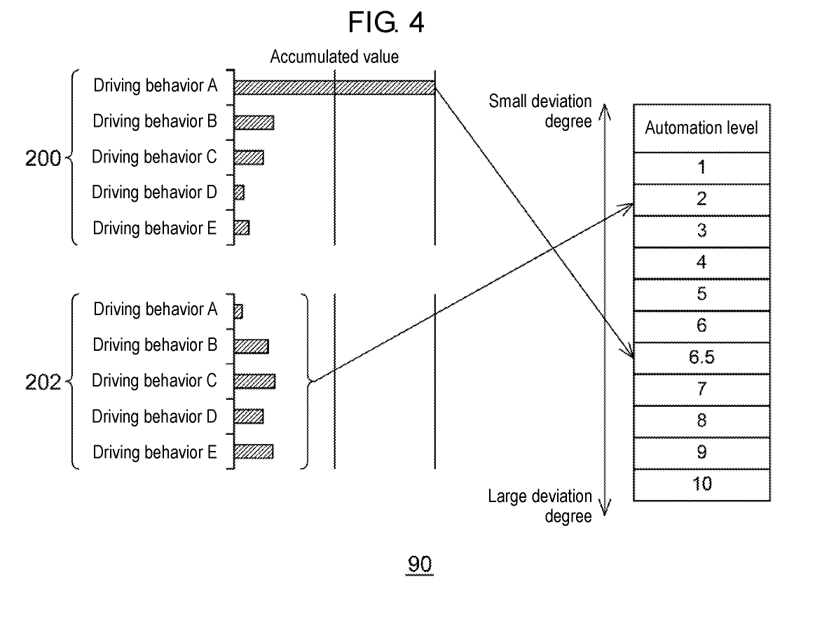

FIG. 4 illustrates an outline of action of automation level determination section 90. In FIG. 4, first histogram 200 and second histogram 202 are illustrated as an example of the input from histogram generator 84. For convenience of comparison, the driving behaviors A to E are commonly included in first histogram 200 and second histogram 202. However, the driving behaviors different from each other may be included in first histogram 200 and second histogram 202. In first histogram 200, the accumulated value for the driving behavior A is much larger than the accumulated values for other driving behaviors. For this reason, the deviation degree increases in first histogram 200. On the other hand, second histogram 202 does not include the driving behavior having the markedly large accumulated value. For this reason, the deviation degree decreases in second histogram 202. The automation level “6.5” is selected for first histogram 200 having the larger deviation degree, and the automation level “2” is selected for second histogram 202 having the smaller deviation degree. This is because the reliability of the selection of the driving behavior is enhanced with increasing deviation degree by including the protruding accumulated value. The description returns to FIG. 3.

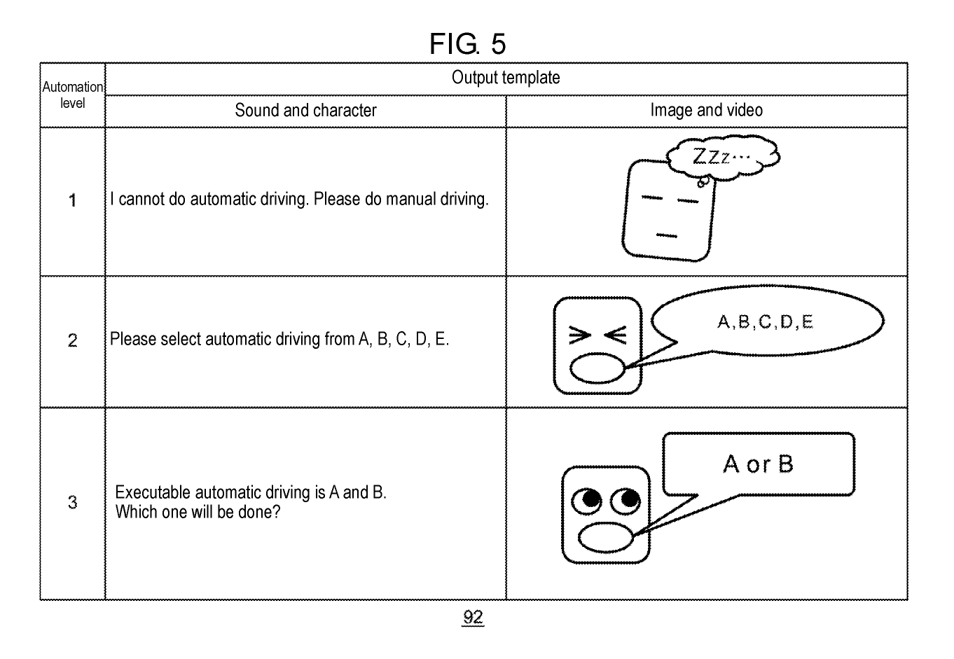

Output template storage 92 stores output templates corresponding to the automation levels defined at the plurality of stages respectively. The output template means a format indicating the driving behavior estimated by driving behavior estimator 70 to the driver. The output template may be prescribed as sound and character, or image and video. FIG. 5 illustrates a configuration of the output template stored in output template storage 92. For the automation level “1”, the sound and character “I cannot do automatic driving. Please do manual driving.” are stored, and the image and video that do not encourage the driver to perform the input are stored.

For the automation level “2”, the sound and character “Please select automatic driving from A, B, C, D, E.” are stored, and the image and video that encourage the driver to input one of A to E are stored. At this point, the driving behavior is input to A to E. The number of input driving behaviors is not limited to 5. For the automation level “3”, the sound and character “Executable automatic driving is A and B. Which one will be done?” are stored, and the image and video that encourage the driver to select A or B are stored. In the image and video, the message “A or B” may be displayed in Japanese.

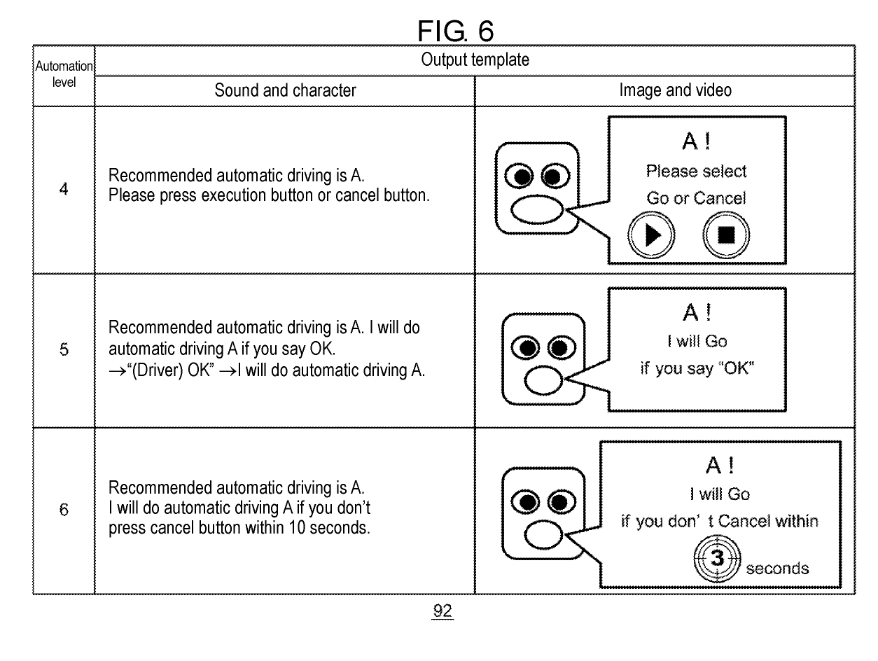

FIG. 6 illustrates a configuration of another output template stored in output template storage 92. For the automation level “4”, the sound and character “Recommended automatic driving is A. Please select execution button or cancel button.” are stored, and the image and video that encourage the driver to select execution or cancel are stored. In the image and video, the message “Please select execution or cancel of A.” may be displayed in Japanese. For the automation level “5”, the sound and character “Recommended automatic driving is A. I will do A if you say OK.” are stored, and the sound and character “I will do automatic driving A.” are also stored in order to perform the output when the driver inputs a response of “OK”. The image and video that encourage the driver to vocalize “OK” are stored. In the image and video, the message “Please say “OK” to do A” may be displayed in Japanese. For the automation level “6”, the sound and character “Recommended automatic driving is A. I will do A if you don't press cancel button within 10 seconds.” are stored, and the image and video that count down time until reception of the cancel button is ended are store. In the image and video, the message “I will do A if you don't press cancel button within 3 seconds.” may be displayed in Japanese.

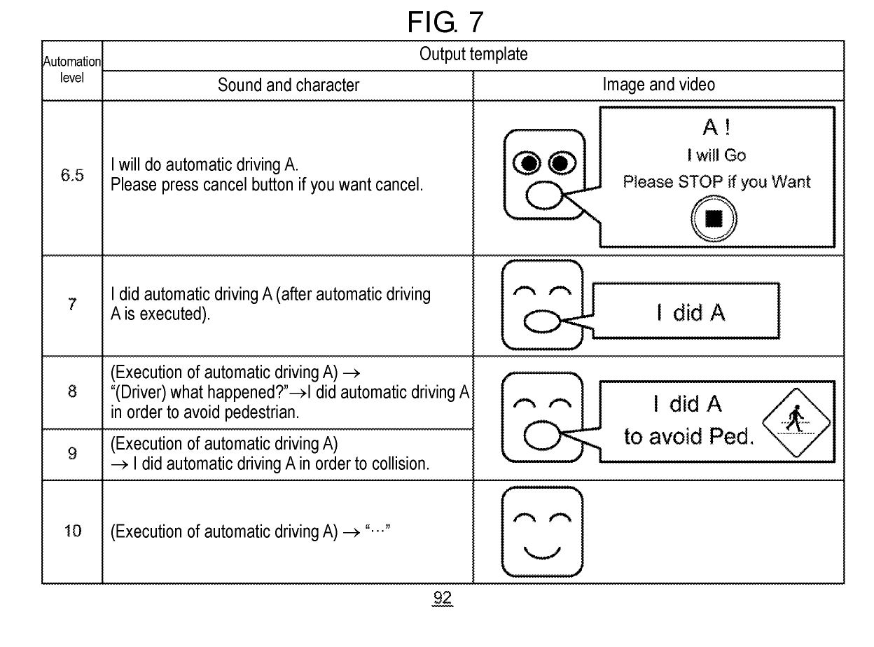

FIG. 7 illustrates a configuration of still another output template stored in output template storage 92. For the automation level “6.5”, the sound and character “I will do automatic driving A. Please press cancel button if you want cancel.” are stored, and the image and video that indicate the cancel button are stored. In the image and video, the message “I will do A. Please press cancel button if you want cancel.” may be displayed in Japanese. For the automation level “7”, the sound and character “I did automatic driving A.” that should be output after automatic driving A is executed are stored, and the image and video that notify the driver of the execution of automatic driving A are stored. In the image and video, the message “I did A” may be displayed in Japanese.

For the automation level “8”, the sound and character “I did automatic driving A in order to avoid pedestrian.” that should be output when the driver inputs “What happened?” after automatic driving A is executed are stored. The image and video that notify the driver of the execution of automatic driving A and its reason are stored. In the image and video, the message “I did A in order to avoid pedestrian.” may be displayed in Japanese. For the automation level “9”, the sound and character “I did automatic driving A in order to avoid collision.” that should be output after automatic driving A is executed are stored, and the same image and video as the image and video at the automation level 8 are stored. For the automation level “10”, the sound and character are not stored, but the image and video that do not encourage the driver to perform the input are stored.

Referring to FIGS. 5 to 7, the output templates corresponding to the 11 stage automation levels respectively are classified into four kinds. A first kind is the output template at the first-stage automation level including the automation level “1”. This is the output template at the lowest automation level. The driver is not notified of the driving behavior in the output template at the first-stage automation level. A second kind is the output template at the second-stage automation level including the automation levels “2” to “6.5”. This is the output template at the automation level higher than the first-stage automation level. The driver is notified of the option of the driving behavior in the output template at the second-stage automation level. The option includes the stop.

A third kind is the output template at the third-stage automation level including the automation levels “7” to “9”. This is the output template at the automation level higher than the second-stage automation level. The driver is notified of the execution reporting of the driving behavior in the output template at the third-stage automation level. A fourth kind is the output template at the fourth-stage automation level including the automation level “10”. This is the output template at the automation level higher than the third-stage automation level, and is the output template at the highest automation level. The driver is not notified of the driving behavior in the output template at the fourth-stage automation level. The description returns to FIG. 3.

Generator 94 receives the selected automation level and the plurality of kinds of driving behaviors from automation level determination section 90. Generator 94 acquires the output template corresponding to one automation level selected by automation level determination section 90 among the plurality of output template stored in output template storage 92. Generator 94 generates the presentation information by applying the plurality of kinds of driving behaviors to the acquired output template. This corresponds to fitting of the driving behavior in options “A” to “E” included in the output templates of FIGS. 5 to 7. Generator 94 outputs the presentation information that is generated.

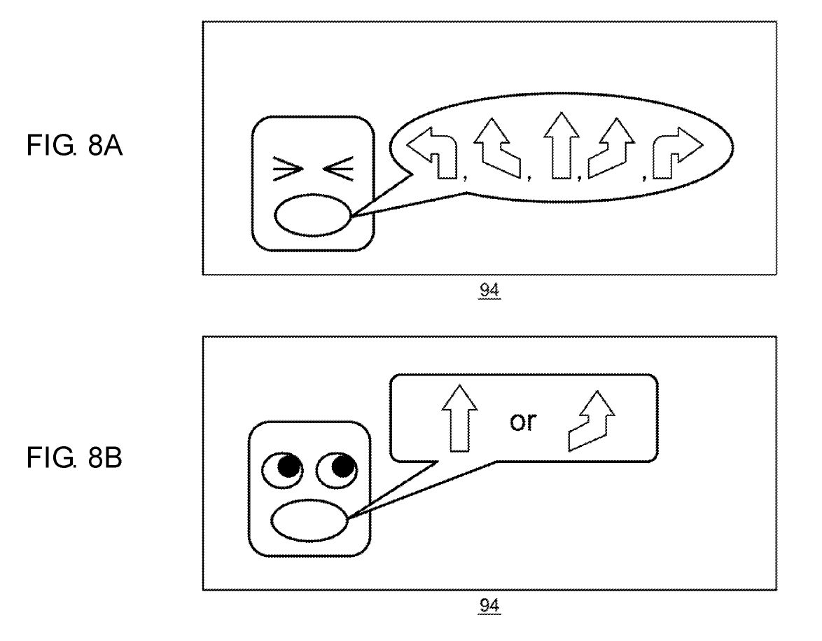

FIGS. 8A and 8B illustrate a configuration of the presentation information generated by generator 94. FIG. 8A illustrates the presentation information in which the driving behaviors of left turn, change to left lane, going straight, change to right lane, and right turn are fitted in the image and video of the output template at the automation level “2”. FIG. 8B illustrates the presentation information in which the driving behaviors of going straight and change to right lane are fitted in the image and video of the output template at the automation level “3”. The description returns to FIG. 3.

Output unit 96 receives the presentation information from generator 94, and outputs the presentation information. In the case that the presentation information is the sound and character, output unit 96 outputs the presentation information to speaker 6 in FIG. 2 through image and sound output unit 51 in FIG. 1. Speaker 6 outputs the sound message of the presentation information. In the case that the presentation information is the image and video, output unit 96 outputs the presentation information to head-up display 2a or center display 2b in FIG. 2 through image and sound output unit 51 in FIG. 1. Head-up display 2a or center display 2b displays the image of the presentation information. Automatic driving control device 30 in FIG. 1 controls the automatic driving of vehicle 100 based on a control command corresponding to one of the plurality of driving behaviors.

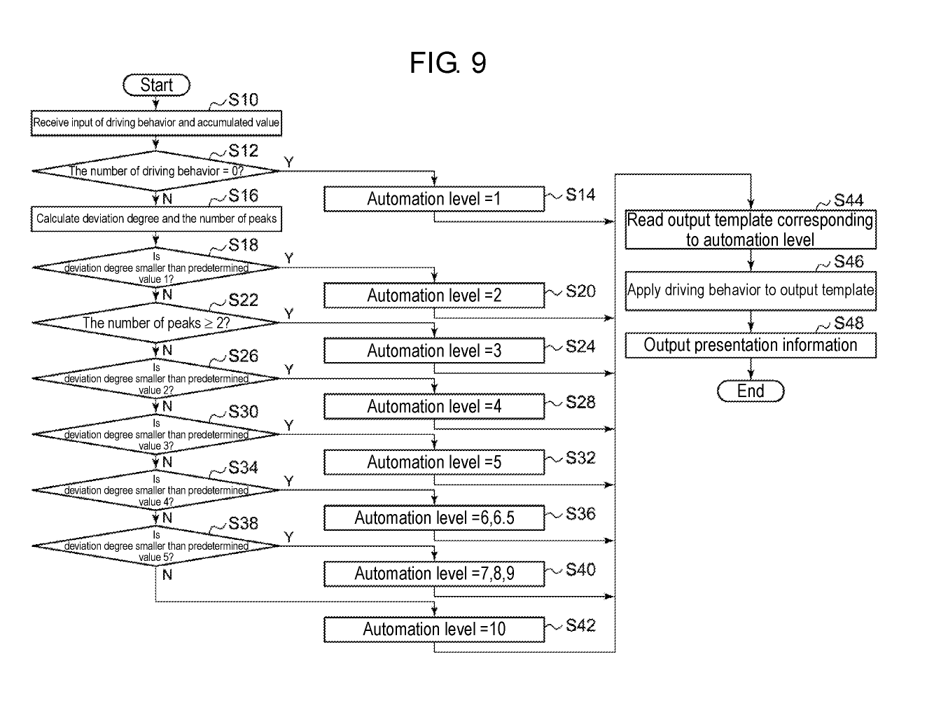

Action of driving assistance device 40 having the above configuration will be described below. FIG. 9 is a flowchart illustrating an output procedure of display controller 72. Automation level determination section 90 receives the driving behavior and the accumulated value (S10). When the number of driving behaviors is 0 (Y in S12), automation level determination section 90 selects the automation level “1” (S14). When the number of driving behaviors is not 0 (N in S12), automation level determination section 90 calculates the deviation degree and the number of peaks (S16). When the deviation degree is smaller than predetermined value 1 (Y in S18), automation level determination section 90 selects the automation level “2” (S20). When the deviation degree is not smaller than predetermined value 1 (N in S18), and when the number of peaks is greater than or equal to 2 (Y in S22), automation level determination section 90 selects the automation level “3” (S24).

When the number of peaks is less than 2 (N in S22), and when the deviation degree is smaller than predetermined value 2 (Y in S26), automation level determination section 90 selects the automation level “4” (S28). When the deviation degree is not smaller than predetermined value 2 (N in S26), and when the deviation degree is smaller than predetermined value 3 (Y in S30), automation level determination section 90 selects the automation level “5” (S32). When the deviation degree is not smaller than predetermined value 3 (N in S30), and when the deviation degree is smaller than predetermined value 4 (Y in S34), automation level determination section 90 selects the automation level “6” or “6.5” (S36). When the deviation degree is not smaller than predetermined value 3 and smaller than predetermined value 4, the automation level “6” is selected in the case that the deviation degree is slightly low, and the automation level “6.5” is selected in the case that the deviation degree is slightly high.

When the deviation degree is not smaller than predetermined value 4 (N in S34), and when the deviation degree is smaller than predetermined value 5 (Y in S38), automation level determination section 90 selects one of the automation levels “7”, “8”, “9” (S40). When the deviation degree is not smaller than predetermined value 4 and smaller than predetermined value 5, the automation level “7” is selected in the case that the deviation degree is slightly low, the automation level “8” is selected in the case that the deviation degree is slightly high, and the automation level “9” is selected in the case that the deviation degree is higher. When the deviation degree is not smaller than predetermined value 5 (N in S38), automation level determination section 90 selects the automation level “10” (S42). Generator 94 reads the output template corresponding to the automation level (S44), and applies the driving behavior to the output template (S46). Output unit 96 outputs the presentation information (S48). At this point, predetermined value 1<predetermined value 2<predetermined value 3<predetermined value 4<predetermined value 5 holds.

According to the exemplary embodiment, the presentation information is generated using the output template corresponding to the automation level, which is selected based on the estimation result obtained using the driving behavior model generated by the machine learning or the like, so that the driver can be notified of the reliability of the presentation information. One automation level is selected based on the deviation degree of the reliability of the driving behavior that is the estimation result obtained using the driving behavior model generated by the machine learning or the like, so that the reliability of the driving behavior and the automation level can be correlated with each other. One automation level is selected based on the number of peaks of the reliability of the driving behavior that is the estimation result obtained using the driving behavior model generated by the machine learning or the like, so that the reliability of the driving behavior and the automation level can be correlated with each other. The accumulated value is used as the reliability, so that the automation level can be selected in the case that the accumulated value is output by the estimator. The output template varies at different automation levels, so that the driver can recognize the automation level. The output template varies at different automation levels, so that the output template suitable for the automation level can be used.

While the exemplary embodiment of the present invention has been described above with reference to the drawings, the functions of the above devices and processors can be implemented by a computer program. A computer that implements the above functions through the execution of the program includes an input device such as a keyboard, a mouse, and a touch pad, an output device such as a display and a speaker, a Central Processing Unit (CPU), a storage device such as a ROM, a RAM, a hard disk device, and an Solid State Drive (SSD), a reading device that reads information from a recording medium such as a Digital Versatile Disk Read Only Memory (DVD-ROM) and a USB memory, and a network card that conducts communication through a network, and the respective elements are connected to one another through a bus.

The reading device reads the program from the recording medium in which the program is recorded, and stores the program in the storage device. Alternatively, the network card communicates with a server device connected to the network, and a program, which implements the respective functions of the above devices and is downloaded from the server device, is stored in the storage device. The CPU copies the program stored in the storage device onto the RAM, and sequentially reads instructions included in the program from the RAM to execute the instructions, thereby implementing the functions of the devices.

An outline of one aspect of the present invention is as follows. A driving assistance device according to an aspect of the present invention includes an automation level determination section, a generator, and an output unit. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

According to this aspect, the output template corresponding to the automation level, which is selected based on the estimation result obtained using the driving behavior model generated by the machine learning or the like is used, so that the driver can be notified of the reliability of the presentation information.

The reliability that becomes the processing target in the automation level determination section may be the accumulated value for each driving behavior. In this case, the accumulated value is used as the reliability, so that the automation level can be selected in the case that the accumulated value is output by the estimator.

The reliability that becomes the processing target in the automation level determination section may be a likelihood for each driving behavior. In this case, the likelihood is used as the reliability, so that the automation level can be selected in the case that the likelihood is output by the estimator.

In the output template, which becomes the using target in the generator and corresponds to each of the automation levels defined at the plurality of stages, (1) notification of the driving behavior may not be made at a first-stage automation level, (2) notification of an option of the driving behavior may be made at a second-stage automation level higher than the first-stage automation level, (3) notification of execution reporting of the driving behavior may be made at a third-stage automation level higher than the second-stage automation level, and (4) notification of the driving behavior may not be made at a fourth-stage automation level higher than the third-stage automation level. In this case, the output template varies at different automation levels, so that the driver can recognize the automation level.

Another aspect of the present invention provides an automatic driving control device. The automatic driving control device includes an automation level determination section, a generator, an output unit, and an automatic driving controller. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The automatic driving controller controls the automatic driving of the vehicle based on the output unit that outputs the presentation information generated by the generator and one of the plurality of kinds of driving behaviors.

Still another aspect of the present invention provides a vehicle. The vehicle includes an automation level determination section, a generator, and an output unit. The automation level determination section is a vehicle including a driving assistance device, and the driving assistance device selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

Still another aspect of the present invention provides a driving assistance system. The driving assistance system includes a server that generates a driving behavior model and a driving assistance device that receives the driving behavior model generated by the server. The driving assistance device includes an automation level determination section, a generator, and an output unit. The automation level determination section selects one of automation levels defined at a plurality of stages based on a deviation degree of reliability, the deviation degree corresponding to each of a plurality of kinds of driving behaviors that are estimation results obtained using a driving behavior model. The generator generates presentation information by applying the plurality of kinds of driving behaviors to an output template corresponding to one automation level selected by the automation level determination section in output templates corresponding to the automation levels defined at the plurality of stages respectively. The output unit outputs the presentation information generated by the generator.

Still another aspect of the present invention provides a driving assistance method. In the driving assistance method, one of automation levels defined at a plurality of stages is selected based on a deviation degree of reliability, the deviation degree corresponding to each of a plurality of kinds of driving behaviors that are estimation results obtained using a driving behavior model. Presentation information is generated by applying the plurality of kinds of driving behaviors to an output template corresponding to one selected automation level in output templates corresponding to the automation levels defined at the plurality of stages respectively. The generated presentation information is output.

The present invention has been described above based on the exemplary embodiment. It will be understood by those skilled in the art that these exemplary embodiments are merely examples, other exemplary modifications in which components and/or processes of the exemplary embodiments are variously combined are possible, and the other exemplary modifications still fall within the scope of the present invention.

In the exemplary embodiment, driving behavior estimator 70 is included in controller 41 of driving assistance device 40. Alternatively, driving behavior estimator 70 may be included in controller 31 of automatic driving control device 30. The modification can improve the degree of freedom in the configuration.

In the exemplary embodiment, driving behavior model 80 is generated by driving behavior learning unit 310, and transmitted to driving behavior estimator 70. Alternatively, driving behavior model 80 may be pre-installed in driving behavior estimator 70. The modification can facilitate the configuration.

In the exemplary embodiment, driving behavior estimator 70 performs the estimation using the driving behavior model generated by the deep learning in which the neural network is used. Alternatively, driving behavior estimator 70 may use the driving behavior model in which the machine learning other than the deep learning is used. An example of the machine learning other than the deep learning is the SVM. Driving behavior estimator 70 may use a filter generated by statistical processing. An example of the filter is the collaborative filtering. In the collaborative filtering, the driving behavior having the high correlation value is selected by calculating the correlation value between driving history or traveling history corresponding to each driving behavior and the input parameter. A probability is indicated by the correlation value, so that the correlation value is said to be the likelihood, and corresponds to the reliability. In this modification, the likelihood is used as the reliability, so that the automation level can be selected in the case that the likelihood is output by estimator 82. Driving behavior estimator 70 may be a rule that previously holds a pair of input and output indicating that each of the plurality of kinds of behaviors uniquely correlated by the machine learning or the filter is dangerous or not dangerous.

### INDUSTRIAL APPLICABILITY

The present invention is applicable to automatic driving vehicle.

### REFERENCE MARKS IN THE DRAWINGS

2 notification device

2a head⁻up display

2b center display

4 input device

4a first operating unit

4b second operating unit

6 speaker

8 wireless device

10 driving operating unit

20 detector

30 automatic driving control device

31 controller

32 storage unit

33 I/O unit

40 driving assistance device

41 controller

42 storage unit

43 I/O unit

50 operation input unit

51 image and sound output unit

52 detection information input unit

53 command IF

54 behavior information input unit

55 command output unit

56 communication IF

70 driving behavior estimator

72 display controller

80 driving behavior model

82 estimator

84 histogram generator

90 automation level determination section

92 output template storage

94 generator

96 output unit

100 vehicle

300 server

302 network

310 driving behavior learning unit

500 driving assistance system

1. A driving assistance device comprising:
an automation level determination section that selects one of automation levels defined at a plurality of stages based on deviation degrees of reliability, the deviation degrees respectively corresponding to a plurality of kinds of driving behaviors that are estimation results obtained using a driving behavior model;
a generator that generates presentation information by applying the plurality of kinds of driving behaviors to an output template corresponding to the one of automation levels selected by the automation level determination section among output templates respectively corresponding to the automation levels; and
an output unit that outputs the presentation information generated by the generator.

2. The driving assistance device according to claim 1, wherein the reliability that becomes a processing target in the automation level determination section is an accumulated value corresponding to each of the plurality of kinds of driving behaviors.

3. The driving assistance device according to claim 1, wherein the reliability that becomes a processing target in the automation level determination section is a likelihood corresponding to each of the plurality of kinds of driving behaviors.

4. The driving assistance device according to claim 1, wherein in the output template that becomes a using target in the generator and corresponds to each of the automation levels defined at the plurality of stages, (1) the driving behavior is non-notification at a first-stage automation level, (2) notification of an option of the driving behavior is made at a second-stage automation level higher than the first-stage automation level, (3) notification of execution reporting of the driving behavior is made at a third-stage automation level higher than the second-stage automation level, and (4) the driving behavior is non-notification at a fourth-stage automation level higher than the third-stage automation level.

5. (canceled)

6. (canceled)

7. A driving assistance system comprising:
a server that generates a driving behavior model; and
a driving assistance device that receives the driving behavior model generated by the server,
wherein the driving assistance device includes:
an automation level determination section that selects one of automation levels defined at a plurality of stages based on deviation degrees of reliability, the deviation degrees respectively corresponding to a plurality of kinds of driving behaviors that are estimation results obtained using the driving behavior model;
a generator that generates presentation information by applying the plurality of kinds of driving behaviors to an output template corresponding to the one of automation levels selected by the automation level determination section among output templates respectively corresponding to the automation levels; and
an output unit that outputs the presentation information generated by the generator.

8. A driving assistance method comprising the steps of:
selecting one of automation levels defined at a plurality of stages based on deviation degrees of reliability, the deviation degrees respectively corresponding to a plurality of kinds of driving behaviors that are estimation results obtained using a driving behavior model;
generating presentation information by applying the plurality of kinds of driving behaviors to an output template corresponding to one selected automation level in output templates corresponding to the automation levels defined at the plurality of stages respectively; and
outputting the presentation information that is generated.

9. (canceled)

10. The driving assistance device according to claim 7, wherein the reliability that becomes a processing target in the automation level determination section is an accumulated value corresponding to each of the plurality of kinds of driving behaviors.

11. The driving assistance device according to claim 7, wherein the reliability that becomes a processing target in the automation level determination section is a likelihood corresponding to each of the plurality of kinds of driving behaviors.

12. The driving assistance device according to claim 7, wherein in the output template that becomes a using target in the generator and corresponds to each of the automation levels defined at the plurality of stages, (1) the driving behavior is non-notification at a first-stage automation level, (2) notification of an option of the driving behavior is made at a second-stage automation level higher than the first-stage automation level, (3) notification of execution reporting of the driving behavior is made at a third-stage automation level higher than the second-stage automation level, and (4) the driving behavior is non-notification at a fourth-stage automation level higher than the third-stage automation level.

13. The driving assistance method according to claim 8, wherein the reliability that becomes a processing target is an accumulated value corresponding to each of the plurality of kinds of driving behaviors.

14. The driving assistance method according to claim 8, wherein the reliability that becomes a processing target-is a likelihood corresponding to each of the plurality of kinds of driving behaviors.

15. The driving assistance method according to claim 8, wherein in the output template that becomes a using target and corresponds to each of the automation levels defined at the plurality of stages, (1) the driving behavior is non-notification at a first-stage automation level, (2) notification of an option of the driving behavior is made at a second-stage automation level higher than the first-stage automation level, (3) notification of execution reporting of the driving behavior is made at a third-stage automation level higher than the second-stage automation level, and (4) the driving behavior is non-notification at a fourth-stage automation level higher than the third-stage automation level.
